(19) United States
(12) Patent Application Publication
(10) Pub. No.: US 2025/0107483 A1
(43) Pub. Date: Apr. 3, 2025

(54) TYPE OF GRASS TRIMMER AND METHOD OF USING THE SAME

(71) Applicant: Yongkang Jialemei Industry and Trade Co., Ltd., Jinhua (CN)

(72) Inventor: Yikang Tong, Shangrao (CN)

(73) Assignee: Yongkang Jialemei Industry and Trade Co., Ltd., Jinhua (CN)

(21) Appl. No.: 18/373,974

(22) Filed: Sep. 28, 2023

(51) Int. Cl. A01D 34/69; A01D 34/68; A01D 34/81; A01D 34/90; A01D 101/00

(52) U.S. Cl. CPC A01D 34/69; A01D 34/6806; A01D 34/81; A01D 34/90; A01D 2101/00

(57) ABSTRACT

This invention provides a grass trimmer and a method of using the same. The grass trimmer comprises a machine head including at least one electric motor, a grass trimmer head driven by the electric motor, and a housing for containing the electric motor. And a base including a shell. In addition, there is a trimming wheel device and a tank wheel device which assist in moving the grass trimmer head. The tank wheel device and the trimming wheel device form a detachable connection to the base. When trimming is required, the base connects to the trimming wheel device. When mowing is required, the tank wheel device replaces the connection between the trimming wheel device and the base.

### TECHNICAL FIELD

The present invention relates to the technical field of gardening tools and in particular to a grass trimmer and a method of using the same.

### BACKGROUND

Green vegetation is an indispensable environmental element for our human beings, and the awareness of greening is becoming more and more deeply rooted in people's hearts, whether it's a golf course, a soccer field, a mansion, a villa's courtyard or an ordinary residential area, green turf is everywhere, bringing vitality and vigor to people's lives, but if it's left to people's tending to the turf, this turf will become high and low and messy. As a tending to the turf, the grass trimmer is favored by more and more users. As a gardening tool, the grass trimmer is favored by more and more users. The grass trimmer includes the grass trimmer head, and the grass trimmer rotates the grass beating tool mounted thereon by the high-speed rotation of the grass trimmer head to achieve the trimming of the grass.

However, the traditional grass trimmer is difficult to disassemble; cannot adjust and optimize the performance and function of each component according to different scenarios and needs: is prone to malfunction and damage: is difficult to clean, repair and maintain each component: occupies space and has a high transportation cost when not in use; and is inconvenient to store and carry. For example, the grass trimmer disclosed in U.S. Pat. No. 9,961,829 cannot be disassembled, cannot be adjusted according to the environment, is difficult to repair and clean, and occupies space and increases transportation cost when not in use: similarly, the grass trimmer disclosed in U.S. Patent No. US20230172102A1 cannot be disassembled, has a single use, is difficult to repair and clean when malfunctioning, and is difficult to store and transport. It is difficult to maintain and clean in case of malfunction, difficult to store, and inconvenient to transport.

Based on the above problems, it is necessary to propose a new grass trimmer, which can replace parts according to different scenarios and needs, make it more convenient to clean, repair and maintain each part, and prolong the service life, and at the same time save space and transportation cost, and be convenient to store and carry.

### SUMMARY

The present invention provides a grass trimmer comprising a machine head, a machine head comprising at least one electric motor, a grass trimmer head actuated by the electric motor, and a housing for holding the electric motor: a base, comprising a shell for supporting the machine head: a trimming wheel device to assist in moving the grass trimmer head as the grass trimmer head performs trimming operations; and at least one tank wheel device for assisting movement of the grass trimmer head when the grass trimmer head is performing having operations, the tank wheel device for assisting movement of the grass trimmer head, wherein both the tank wheel device and the trimming wheel device form a removable connection with the base, wherein the base connects to the trimming wheel device when trimming work is required, and wherein the tank wheel device replaces the trimming wheel device with the base when having work is required.

The present invention also provides a grass trimmer comprising: a machine head, said machine head comprising at least one electric motor, a grass trimmer head actuated by said electric motor, and a housing for holding said electric motor; and a base, said base comprising a shell for supporting said machine head; and a moving mechanism, said moving mechanism removably attachable to said base for supporting said grass trimmer head and for assisting in the movement of said grass trimmer head during operation of said grass trimmer head:
wherein the moving mechanism includes a trimming wheel device and a tank wheel device, wherein the trimming wheel device forms a fixed connection with the tank wheel device, and wherein a supporting direction of the trimming wheel device is transverse to a supporting direction of the tank wheel device: wherein the tank wheel device forms a support for and assists in the movement of the grass trimmer head when the grass trimmer head performs a having operation, and wherein the trimming wheel device forms a support for and assists in the movement of the grass trimmer head when the grass trimmer head performs a trimming operation.

The present invention also provides a method of using a grass trimmer comprising providing a grass trimmer, the grass trimmer comprising at least one electric motor and a grass trimmer head, a base, a trimming wheel device and a tank wheel device actuated by the electric motor, wherein the at least one tank wheel device is detachably coupled to the base and the at least one trimming wheel device is detachably coupled to the base and replaces the at least one of the tank wheel device in use:

The method comprises mounting a trimming wheel device on a base so that the trimming wheel device supports a grass trimmer and pushes the grass trimmer to move for trimming operations: removing the trimming wheel device and mounting a tank wheel device on the base so that the tank wheel device supports the grass trimmer and pushes the grass trimmer to move for mowing operations; and removing all of the tank wheel device and trimming wheel device from the base and lifting the grass trimmer to perform mowing operations on plants in high places.

The present invention provides a grass trimmer comprising a machine head comprising at least one electric motor, a grass trimmer head actuated by the electric motor, and a housing for holding the electric motor; and a base comprising a shell for supporting the machine head; and a moving mechanism removably attached to the base for supporting the grass trimmer head and for assisting in the movement of the grass trimmer head while the grass trimmer head is in operation; and a main handle removably attached to the machine head for holding the grass trimmer for operation; and the main handle comprising a connecting rod and a handle, the connecting rod being fixedly connected to the handle; and a secondary handle detachably attached to the connecting rod for assisting the main handle in controlling the grass trimmer for operation; and the secondary handle comprising a connecting pipe, an auxiliary handle, and an adjustment handle, the auxiliary handle being rotatably attached to the connecting pipe, the adjustment handle being threaded through the auxiliary handle and against the connecting pipe:
and the connecting pipe having a generally cylindrical shaped inner wall surface, the inner wall surface defining a space, the space accommodating the connecting rod, the connecting pipe being further provided with an opening, the opening defining a passage for the main handle to enter the space, the connecting pipe being further provided with a buckle structure, the buckle structure being closable or openable to the opening and restricting the displacement of the main handle entering the space, the connecting pipe being further provided with an angle adjustment mechanism for adjusting the angle between the auxiliary handle and the adjustment handle and the connecting pipe.

### BRIEF DESCRIPTION OF DRAWINGS

In order to explain the technical scheme of this application more clearly, the drawings needed in the implementation will be briefly introduced below. Obviously, the drawings described below are only some implementations of this application. For those skilled in the art, other drawings can be obtained according to these drawings without creative work.

FIG. 1 is an overall schematic view of embodiment I;

FIG. 2 is a top view of embodiment I:

FIG. 3 is a schematic structural diagram of a portion of embodiment I, primarily illustrating the base structure:

FIG. 4 is a schematic structural diagram of a portion of embodiment I, primarily illustrating the base structure:

FIG. 5 is a schematic structural diagram of a portion of embodiment I, primarily illustrating a connecting part structure:

FIG. 6 is a schematic diagram of a structure of a portion of embodiment I, primarily illustrating a first trimming wheel structure:

FIG. 7 is a schematic structural diagram of a portion of embodiment I, primarily illustrating a first tank wheel structure;

FIG. 8 is a schematic diagram of another embodiment I as a whole:

FIG. 9 is an overall schematic diagram of another embodiment I:

FIG. 10 is an overall schematic diagram of another embodiment I:

FIG. 11 is an overall schematic diagram of another embodiment I:

FIG. 12 is an enlarged view of Part A of FIG. 11:

FIG. 13 is an overall schematic diagram of another embodiment I:

FIG. 14 is an overall schematic diagram of embodiment II:

FIG. 15 is an overall schematic diagram of embodiment II:

FIG. 16 is a schematic diagram of the structure of a portion of embodiment II, primarily illustrating the structure of the first connecting piece and the third tank wheel:

FIG. 17 is a schematic structural diagram of a portion of embodiment II, primarily illustrating the structures of the first connecting piece and the third tank wheel;

FIG. 18 is an overall schematic diagram of another embodiment II:

FIG. 19 is a schematic diagram of another preferred embodiment of the present invention:

FIG. 20 is a schematic view of the moving mechanism of the embodiment shown in FIG. 19;

FIG. 21 is an exploded schematic view of FIG. 20;

FIG. 22 is a schematic diagram of Example III;

FIG. 23 is another schematic diagram of embodiment III;

FIG. 24 is an exploded view of embodiment III;

FIG. 25 is an exploded view of embodiment III;

FIG. 26 is an exploded view of a buckle structure;

FIG. 27 is an exploded view of a connecting pipe I;

FIG. 28 is an exploded view of a connecting pipe II;

FIG. 29 is a schematic view of an auxiliary handle;

FIG. 30 is an exploded view of an adjustment handle.

In the drawings:
1000, machine head; 1100, grass trimmer head;
1200, main handle; 1201, connecting rod; 1202, handle; 1203, connecting component; 1204, rod; 1205, first rod; 1206, second rod; 1207, angle adjustment device;
1300, secondary handle;
1400, connecting pipe; 1403, first block; 1404, second block; 1405, buckle ring; 1406, connection platform; 1407, buckle groove; 1408, through hole A; 1409, through hole B; 1410, groove C; 1411, through hole D; 1412, through hole E; 1413, embedded part; 1414, locking part; 1415, gear; 1416, buckle structure; 1417, receiving groove; 1418, inner wall surface;
1500, auxiliary handle; 1501, adjustment box body; 1502, first ring part; 1503, first fixed part; 1504, second fixing part; 1505, first opening; 1506, second opening; 1507, third opening;
1600, locking component;
1700, adjustment handle; 1701, second ring part; 1702, adjustment part; 1703, adjustment base; 1704, blind hole M; 1705, through hole N; 1706, spring; 1707, accommodating groove; 1708, contact surface; 1709, wheel tooth part;
2000, base; 2100, moving mechanism;
3000, trimming wheel device; 3030, first trimming wheel; 3031, first fixing part; 3032, second fixing part; 3033, third card slot; 3034, slotting; 3100, insert block;
4000, tank wheel device; 4040, first tank wheel; 4041, the third fixing part; 4042, groove; 4043, second threaded hole; 4044, sled surface; 4100, connecting boss;
5000, cover shell; 5051, extension part; 5052, inclined layer; 5053, bending layer; 5054, reinforcing rib;
6000, first viewing port; 6061, curved surface;
7000, connecting part; 7071, accommodating cavity; 7072, first threaded hole; 7073, clamping block; 7074, through slot; 7075, protruding block; 7076, third threaded hole; 7100, quick-release part; 7110, fixing hole; 7111, socket;
8000, locking structure; 8081, first main body part; 8082, first hook part; 8083, first fixing block; 8084, first guide strip; 8085, slot opening; 8086, first cavity; 8861, connecting bar; 8087, second cavity; 8088, first card slot; 8089, friction bar; 8811, second fixing block; 8812, third fixing block; 8813, second main body part; 8814, first limiting block; 8815, second limiting block; 8816, second hook part; 8817, second card slot; 8818, third cavity; 8819, fourth cavity; 8820, third orientation department; 8821, fourth orientation department; 8822, fifth cavity;
9000, second viewing port;
9010, second trimming wheel;
9011, first connecting piece; 9111, first extension part; 9112, second extension part; 9113, reinforcing part;
9012, first connecting frame; 9121, first accommodating slot; 9122, second accommodating slot; 9123, fifth threaded hole;
9013, second connecting piece;
9014, second connecting frame;
9015, second tank wheel;
9016, third tank wheel;
9017, installation cavity; 9171, first protruding block; 9172, second protruding block; 9173, fourth threaded hole.

### DESCRIPTION OF EMBODIMENTS

In describing the preferred embodiments, specific termi-nology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

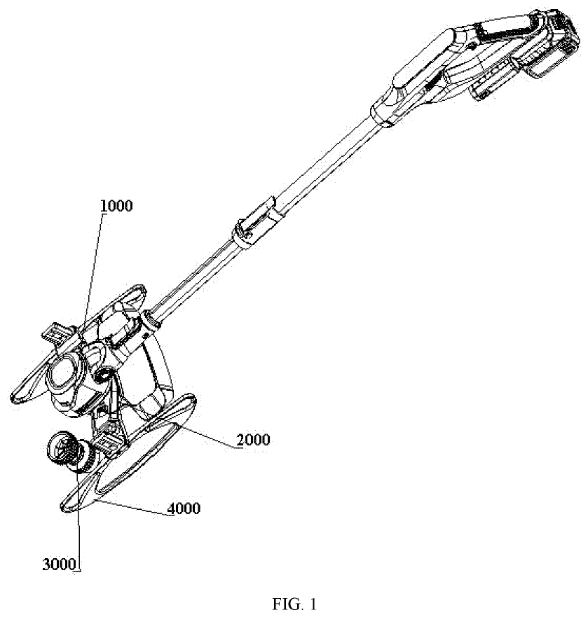

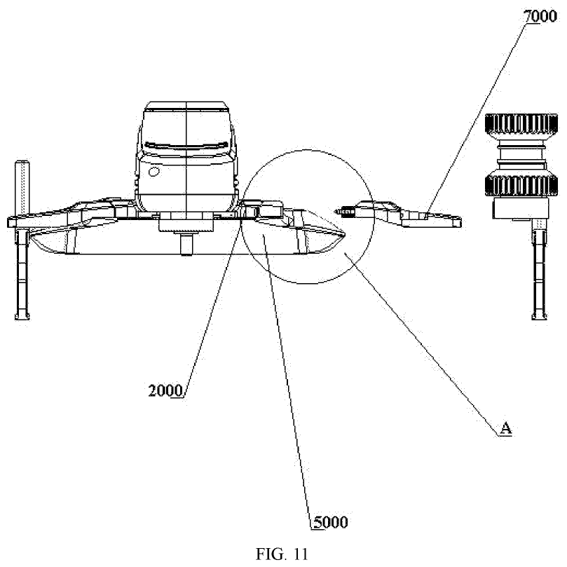

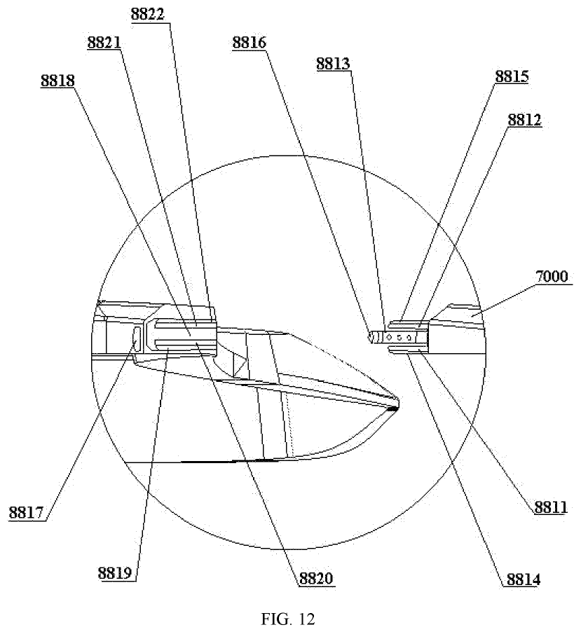

As shown in FIGS. 1 to 13, the grass trimmer provided in embodiment 1, comprises a machine head 1000, a base 2000, a trimming wheel device 3000 and two tank wheel devices 4000, a cover shell 5000; wherein the machine head 1000 comprises at least one electric motor, a grass trimmer head 1100 driven by the electric motor, and a shell for holding the electric motor:

Traditional grass trimmer, its electric motor usually use DC brush 775 model, and the electric motor electric motor shaft diameter is generally 5 mm: in practice, mounted on the 6-inch or even larger blade saw blade, in the case of poor working conditions, it is easy to electric motor shaft crushing or even broken shaft, at the same time, the centrifugal force of the saw blade is greater than the locking force with the nut of the 5-axis blade is easy to come loose.

Therefore, this embodiment is provided with a sleeve shaft on the electric motor, and the direction of rotation of the nut on the sleeve shaft is opposite to the direction of rotation of the shaft of the electric motor, and the diameter of the sleeve shaft is 8 mm; thereby, it can be realized that the more it is screwed, the tighter it becomes and is prevented from falling off, so as to achieve the purpose of increasing the locking force and preventing the loosening of the blade.

In addition, in other embodiments (not shown in the drawings), more durable and robust materials are selected for manufacturing the motor shaft and nut, for example, titanium alloy or stainless steel or other materials are used to improve the strength and durability of the motor shaft and nut: stronger and more reliable locking devices are used, for example, a spring washer or other similar device is used to increase the locking force and prevent the inserts from loosening; and the design of the inserts is optimized, for example, to reduce centrifugal force and improve locking by reducing the diameter of the inserts or increasing the number of inserts.

Specifically, the machine head 1000 has two working modes of trimming and mowing, the trimming wheel device 3000 is used to support the grass trimmer to walk when the grass trimmer performs trimming work, and the two tank wheel devices 4000 are used to support the grass trimmer to walk when the grass trimmer performs mowing work. The shell is mounted to the base 2000, and the two tank wheel devices 4000 are detachably connected to the base 2000, the trimming wheel device 3000 is detachably connected to one of the tank wheel devices 4000, and the cover shell 5000 is integrally or detachably connected to the base 2000, wherein the detachable connection is a snap connection so as to facilitate the replacement of the cover shell 5000. the base 2000 is set up with the two end surfaces close to the machine head 1000 in the direction of departure of the cover shell 5000. This adjustment ensures that the center of gravity of the machine head 1000 is at a lower level and also reduces obstruction of the grass trimmer head 1100.

In some embodiments (not shown in the drawings), stronger and more reliable connections are used between the parts, for example, the use of threaded connectors or other similar connectors improves the strength of the connection and prevents loosening, thereby improving overall safety and durability: the design of the tank wheel device and the trimming wheel device has also been optimized, for example, by increasing the number of wheels or changing the location of the wheels to improve stability and support; and more flexible and adjustable connections are used, for example, the use of a connecting rod with adjustable angles and lengths allows the distance and angle between the machine head and the base to be adjusted as desired.

Further, in other embodiments (not shown in the figures), the design of the base is optimized, for example, to improve stability and support by increasing the width or length of the base: to use lighter and stronger materials to manufacture the base, for example, using materials such as carbon fiber or aluminum alloys reduces weight and improves strength; and to optimize the design of the machine head, for example, to lower the center of gravity and reduce occlusion by reducing the size of the machine head or changing the shape of the machine head.

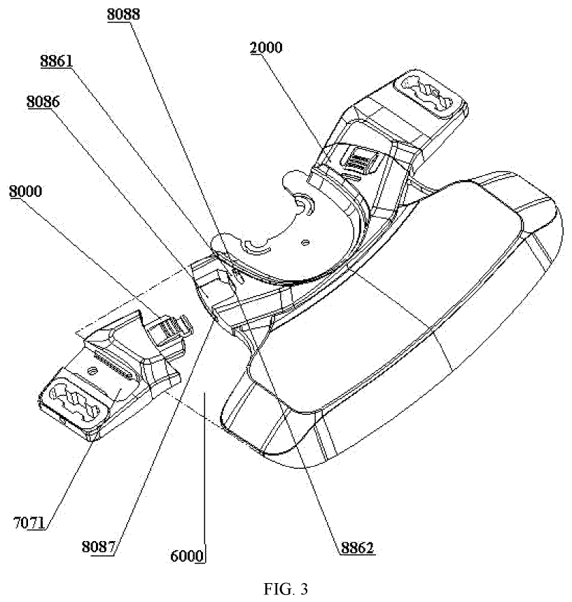

As shown in FIG. 3, in this embodiment, the first viewing port 6000 is opened on the cover shell 5000, and the first viewing port 6000 and the tank wheel device 4000 at least partially overlap in the top view perspective, so that the visible area of the first viewing port 6000 is increased after the tank wheel device 4000 is disassembled, and the angular range for observing the movement trajectory of the grass trimmer head 1100 is improved.

Thereby, when the grass trimmer is trimming a plant at a high place, the tank wheel device 4000 or the trimming wheel device 3000 is removed from the base 2000 through the first viewing port 6000, the observation range can be enlarged so that the movement trajectory of the grass trimmer head 1100 is covered to a lesser extent, which in turn improves the user's visibility, facilitates the trimming of the branches and leaves of the plant, and improves the precision of the trimming of the branches and leaves.

In other embodiments (not shown in the figures), more transparent and durable materials are used to make the cover shell, for example, the use of polycarbonate or similar materials improves transparency and reduces wear and tear; and the design of the viewing ports is optimized, for example, by increasing the number of ports and varying the position of the ports to improve the viewing range and angle; and a more flexible and adjustable design is used, for example, by using a cover shell that can be rotated and adjusted in angle.

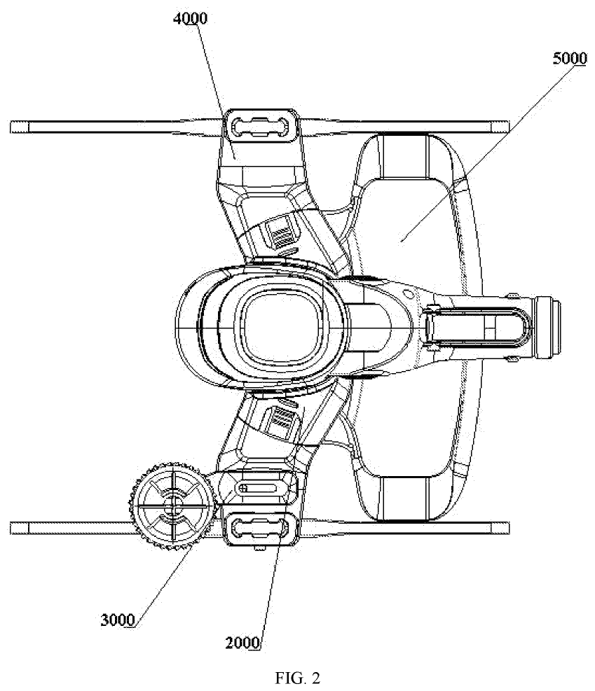

As shown in FIGS. 2 through 8, in this embodiment, the tank wheel device 4000 includes a first tank wheel 4040 and a connecting part 7000: the connecting part 7000 is releasably coupled to the base 2000 at one end, the first tank wheel 4040 is releasably coupled to the connecting part 7000 at the other end, and the trimming wheel device 3000 is releasably coupled to the connecting part 7000.

This structure can facilitate the installation, disassembly and maintenance of the trimming wheel device 3000 without the need to dismantle the machine head 1000 as a whole after the trimming wheel device 3000 is broken: at the same time, when pruning plants in high places, the tank wheel device 4000 can be directly dismantled without the need to dismantle them individually, thereby improving the degree of utilization.

In other embodiments (not shown in the figures), the connecting part design is also optimized, for example, by increasing the number of connecting parts or changing the location of the connecting parts to improve stability and support; and stronger and more reliable materials are used to fabricate the tank wheel devices and connecting parts, for example, the use of materials such as titanium alloys or stainless steel can improve strength and durability.

The traditional grass trimmer is usually set base and tank wheel device as an integrated structure, making the overall length of the base longer, so when pruning, the base will block the rotation track of the grass trimmer head, so the user can not accurately see the distance between the grass trimmer head and the plant branches and leaves, resulting in a low degree of visibility for the user, especially when pruning plants in the high places, it is more difficult to see the distance between the grass trimmer head and the plant branches and leaves. The distance between the grass trimmer head, and the plant branches and leaves cannot be accurately trimmed. At the same time, the spacing between the grass trimmer head and the base is small, so that the branches and leaves generated by the grass trimmer head during trimming are stuck in the spacing, which tends to cause the phenomenon of hanging grass.

In order to solve the above problems, the present invention sets the base 2000 and the connecting part 7000 as a detachable connection, so that when it is necessary to trim the plants, connecting part 7000 can be disassembled, so that the movement track of grass trimmer head 1100 will not be blocked, to improve the visibility of the user, to facilitate the trimming of the branches and leaves of the plants, to improve the precision of trimming the branches and leaves, and to reduce the phenomenon of hanging grasses The user can also reduce the weight of grass trimmer. At the same time can also reduce the weight of grass trimmer, so that the user to take more convenient, especially some of the less powerful people, but also be able to prune plants in high places, and thus improve the efficiency of work.

As shown in FIGS. 3 to 5, in this embodiment, the base 2000 and the connecting part 7000 are constructed as a curved surface 6061, due to the properties of the arc, so that the visibility is improved than the general parallel surface; and the arc has a certain angle, so that when the two curved surfaces 6061 are attached to each other, it is not easy to be separated within a certain range of angles, so that the connection between the connecting part 7000 and the base 2000 is more suitable and the strength of the connection is improved.

In other embodiments (not shown in the drawings), the surface where the base and the connecting part meet is not limited to being constructed as a curved surface, but may also be circular, oval, triangular, or any other shape that satisfies the desire to construct the surface where the base and the connecting part meet.

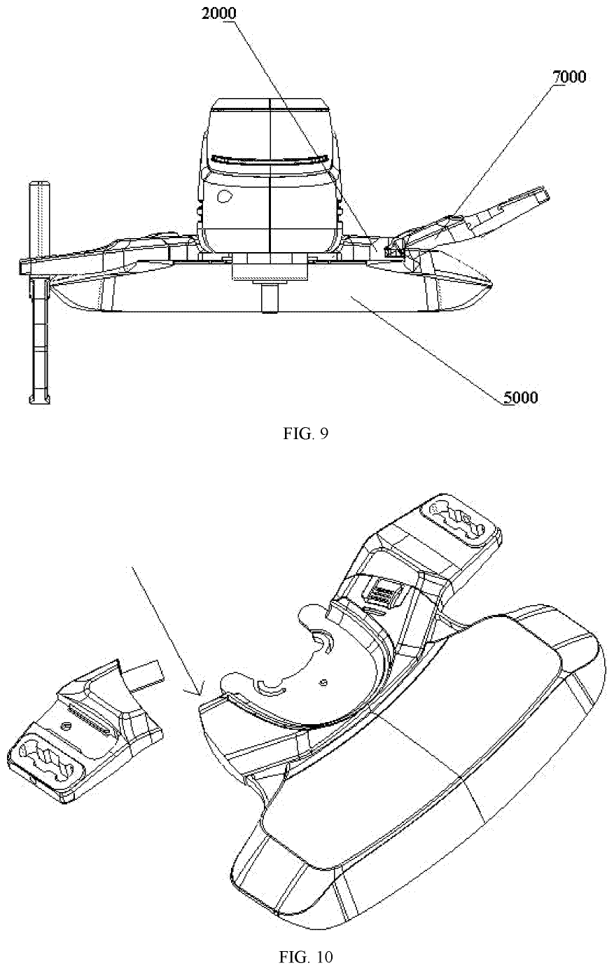

As shown in FIG. 8, in another embodiment, only one connecting part 7000 is detachably connected to the base 2000 and another connecting part 7000 is fixedly connected to the base 2000, and an extension part 5051 is provided between the connecting part 7000 and the cover shell 5000 at the fixedly connected end of the base 2000, wherein the extension part 5051 is a plate-like structure disposed at the end of the cover shell 5000. The plate-like structure: the gap between the connecting part 7000 and the cover shell 5000 can be covered by the action of the extension part 5051 so as to prevent the cut branches and leaves from passing through the gap and injuring the user and to improve the safety of pruning.

In this embodiment, the extension part is a plate made of plastic: in other embodiments (not shown in the drawings), the extension part is not limited to a plastic plate, but can also be an alloy plate, a glass plate, and other plates made of materials that meet the requirements.

In this way, when pruning plants in high places, the detachable connecting part 7000 is removed at one end to ensure that the path of movement of the grass trimmer head 1100 is not blocked so as to improve the user's visibility: while at the other end, when pruning branches and leaves, the cut branches and leaves can be blocked so as to ensure that the cut plants do not hit the user so as to ensure safety during construction.

In some embodiments, stronger and more reliable materials are used to manufacture key components of the grass trimmer, for example, the use of titanium alloys or other similar materials can increase strength and durability; and the design of the machine head is optimized, for example, to lower the center of gravity and reduce occlusion by reducing the size of the machine head or changing the shape of the machine head.

As shown in FIG. 9, in another embodiment, the base 2000 is rotatably connected to at least one of the tank wheel devices 4000, in particular, it may be in the form of a hinge so that when the connecting part 7000 is not required to be used, it only needs to be folded over and then secured to the base 2000 through a hook-like shape; and when the connecting part 7000 is required to be used, it only needs to be When it is required to use the connecting part 7000, it only needs to be unfolded flat to realize grass trimmer having. And the first viewing port 6000 and the retractable tank wheel device 4000 overlap at least partially in the top view perspective to make the visible area of the first viewing port 6000 increase after the tank wheel device 4000 is retracted.

In other embodiments, the base 2000 is telescopically connected to at least one of the tank wheel devices 4000, and the telescoping structure may be particularly similar to the telescoping structure of a table leg stool, so that when the connecting part 7000 is not required to be used, it only needs to be telescoped and secured within the base 2000; and when it is required to be used, the connecting part 7000 only needs to be pulled out and secured for the grass trimmer to hit the grass. And the first viewing port 6000 and the retractable tank wheel device 4000 at least partially overlap in the top view perspective to make the visible area of the first viewing port 6000 increase after the tank wheel device 4000 is retracted.

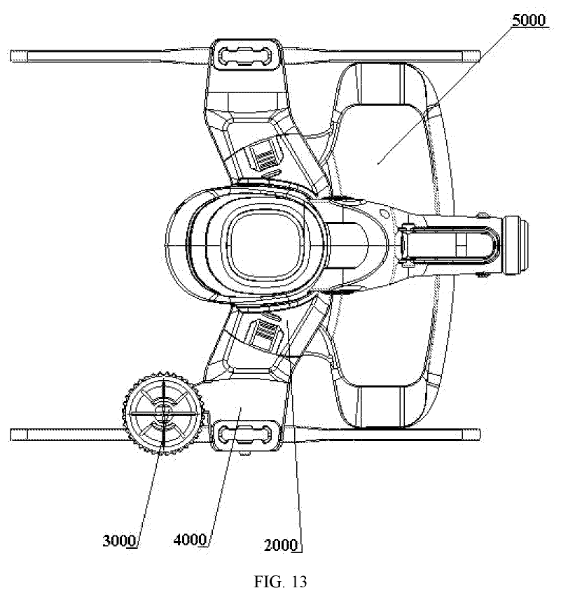

As shown in FIG. 13, in another embodiment, the trimming wheel device 3000 and the tank wheel device 4000 are fixed connections, which may be molded as one piece, or the trimming wheel device 3000 may be bonded or welded to the tank wheel device 4000.

In some embodiments, it may also be a fixed connection using a mortise and tenon joint, which is a type of joint that utilizes a fit of a tenon and a mortise hole to fasten the parts together and that allows for axial and circumferential fixed connections. A mortise and tenon joint can be constructed with straight tenons, slanted tenons, round tenons, etc., so that the trimming wheel device is connected to the tenons and mortise holes on the tank wheel device and is fixed or removed by insertion or knocking in, etc. The advantages of this type of expansion are that it allows for axial and circumferential fixed connections. The advantages of this type of expansion are solid structure and high transmission torque, but the disadvantages are high manufacturing precision and inconvenient assembly and disassembly.

In other embodiments, a snap connection may also be used, which is a connection that utilizes the fit of jaws and slots to fasten parts to each other, and which allows axial and circumferential fixing of the connection. The snap connection can adopt the structure of elastic snap connection, rotary snap connection, sliding snap connection, etc., so that the trimming wheel device is connected to the jaws and slots on the tank wheel device, and the fixing or releasing can be realized by pressing or rotating. The advantage of this expansion method is that the structure is simple and the operation is convenient, but the disadvantage is that the structure is not firm and is easy to loosen or fall off.

In other embodiments, it may also be in the form of an adhesive, which is a type of joint that uses adhesive force to secure the parts together and that allows axial and circumferential fixing of the joint. The adhesive may be in the form of epoxy resin adhesive, polyurethane adhesive, silicone adhesive or other materials, so that the trimming wheel device and the tank wheel device are coated with the adhesive and fixed or disassembled by pressing or heating or the like. The advantages of this expansion method are beautiful structure and good corrosion resistance, but the disadvantages are higher cost and environmental pollution.

As shown in FIGS. 3 to 5, in this embodiment, the connecting part 7000 is provided with a first locking structure 8000 near one end of the base 2000, the locking structure 8000 comprising a connecting snap hook: the connecting snap hook comprises a first main body part 8081 capable of deformation and a first hook part 8082 attached to the first main body part 8081, the first main body part 8081 is provided on the curved surface 6061, the base 2000 is provided with a first cavity 8086 mated with the locking structure 8000, and a first card slot 8088 for inserting the first hook part 8082 is also provided on the base 2000; a connecting bar 8861 is provided between the first cavity 8086 and the first card slot 8088, and the first main body part 8081 forms a slot opening 8085 that receives the connecting bar 8861, and the first hook part 8082 is connected to the 80888081 when the first hook part 8082 is inserted into the first card slot 8088, the connecting bar 8861 snaps into the slot opening 8085, thereby forming a fixing effect.

Specifically, the lock structure 8000 also includes a first fixing block 8083; the first fixing block 8083 is symmetrically set on both sides of the first main body part 8081, and the first fixing block 8083 is inserted into the first cavity 8086 and resists against the side wall of the first cavity 8086, which is used to limit the role of the first main body part 8081: a first guide strip 8084 is provided on the first fixing block 8083, and the ends of the first cavity 8086 extend outward to form the second cavity 8087: the first fixing block 8083 is provided with the first guide strip 8084, the first cavity 8086 two ends extend outward to form the second cavity 8087, the first guide strip 8084 inserted into the second cavity 8087 plays a further role in limiting the locking effect; and the first fixing block 8083 one end for the inclined surface settings, which facilitates the rapid insertion of the first fixing block 8083 into the first cavity 8086. In order to facilitate installation and removal by the user, the first main body part 8081 is also provided with a friction bar 8089.

Thereby, when installing the connecting part 7000, the first guide strip 8084 is inserted against the second cavity 8087, causing the first fixing block 8083 and the first main body part 8081 to be inserted into the first cavity 8086, and then the friction bar 8089 is pressed, causing the first hook part 8082 to be inserted into the first card slot 8088, and the installation can be completed. When it is necessary to disassemble, it is only necessary to press the friction bar 8089, which can increase the friction of the user's fingertip, so that the first hook part 8082 in the first card slot 8088 can be easily pulled out, and then slide the connecting part 7000 to disassemble it.

By the above-described settings, it is possible to facilitate the disassembly and assembly of the connecting part 7000, and thus, when there is no need to use the connecting part 7000, it is only necessary to press the first main body part 8081 so that the first hook part 8082 can be pulled out from within the first card slot 8088, thereby improving the efficiency of the disassembly; and in the case of trimming, it is possible to ensure that the connecting part 7000 is not easily detached from the base 2000, thereby ensuring the stability of trimming and the use of the first trimming wheel 3030 and the first tank wheel 4040, thereby improving the efficiency of trimming.

As shown in FIGS. 10 to 12, in another embodiment, wherein the direction indicated by the arrow in the accompanying figure is the direction in which the locking structure 8000 is inserted.

Specifically, the locking structure 8000 may be connected in a different manner, wherein the locking structure 8000 comprises a second fixing block 8811, a third fixing block 8812, a second main body part 8813: the second fixing block 8811 extends on one side in a direction away from the second main body part 8813 to form a first limiting block 8814, the height of the second fixing block 8811 being higher than the height of the first limiting block 8814, the third fixing block 8812 extends on one side away from the second main body part 8813 to form a second limiting block 8815, the height of the third fixing block 8812 being higher than the height of the second limiting block 8815 the second main body part 8813 is provided with a second hook part 8816, the base 2000 is provided with a second card slot 8817 on the side wall for mating with the second hook part 8816, the base 2000 is provided with a third cavity 8818 on the side near the second card slot 8817, the third cavity 8818 is provided on the side of the base 2000 near the second card slot 8817, the third cavity 8818 includes a third orientation department 8820 for guiding and limiting the second fixing block 8811.
wherein the third cavity 8818 further comprises a fourth orientation department 8821 for guiding and limiting the action of the third fixing block 8812: the third orientation department 8820 extends in a direction away from the third cavity 8818 to form a fourth cavity 8819 for insertion of the first limiting block 8814, which is further limited by the action of the fourth cavity 8819 and the first limiting block 8814: said fourth orientation department 8821 extending in a direction away from said third cavity 8818 to form a fifth cavity 8822 for insertion of said second limiting block 8815, further limited by the action of said fifth cavity 8822 and said second limiting block 8815.

When installation is required, the first limiting block 8814 and second limiting block 8815 are inserted from the side of the base 2000 into the fourth cavity 8819 and fifth cavity 8822, respectively, and then the second hook part 8816 is pressed and snapped into the second card slot 8817 to complete the installation.

Since the second locking structure 8000 is provided on the side wall of the connecting part 7000, so that the overall depth of the second locking structure 8000 is deeper relative to the overall depth of the first locking structure 8000, then the structure of the second locking structure 8000 is more solid, and the unlocking method of the second locking structure 8000 is in the opposite direction to the direction of the grass trimmer walking on the ground, so that the grass trimmer in walking trimming, the second locking structure 8000 is more difficult to unlock, which in turn ensures the overall locking effect.

In other embodiments (not shown in the figures), an elastic retaining ring is used as a locking structure, the elastic retaining ring comprising an annular body portion and a hook portion extending from the main body portion, the main body portion being provided on a curved surface, the base being provided with an annular groove that fits the elastic retaining ring, and the base being provided with a slot for the hook portion to be inserted: when the hook portion is inserted into the slot, the main body portion is compressed inside the annular groove, thereby forming a locking effect. This structure has a simple structure and is easy to install.

In some embodiments, it may also be the case that a threaded connection is used as the locking structure, the threaded connection comprising a threaded sleeve and a threaded pin, the threaded sleeve being provided on the curved surface, the base being provided with threaded holes for mating with the threaded sleeve, and the base being provided with holes for inserting the threaded pin: when the threaded pin is inserted into the holes, the threaded sleeve is screwed into the threaded holes to form a fixing effect. The connection of this structure is fixed and reusable.

In some embodiments, it may also be the case that a magnetic adsorption is used as the locking structure, wherein the magnetic adsorption comprises a magnet and a magnetic material, the magnet is provided on the curved surface, the base is provided with a groove mated with the magnet, and the base is provided with holes for the magnetic material to be inserted: when the magnetic material is inserted into the holes, the magnet is adsorbed inside the groove, forming a locking effect. This structure does not require any other parts or tools and is easy to operate.

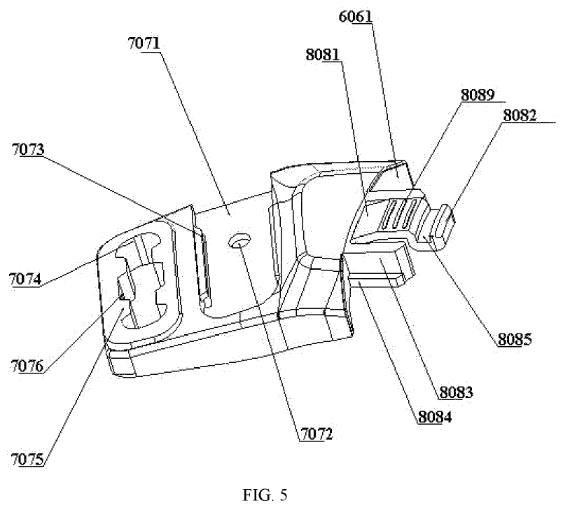

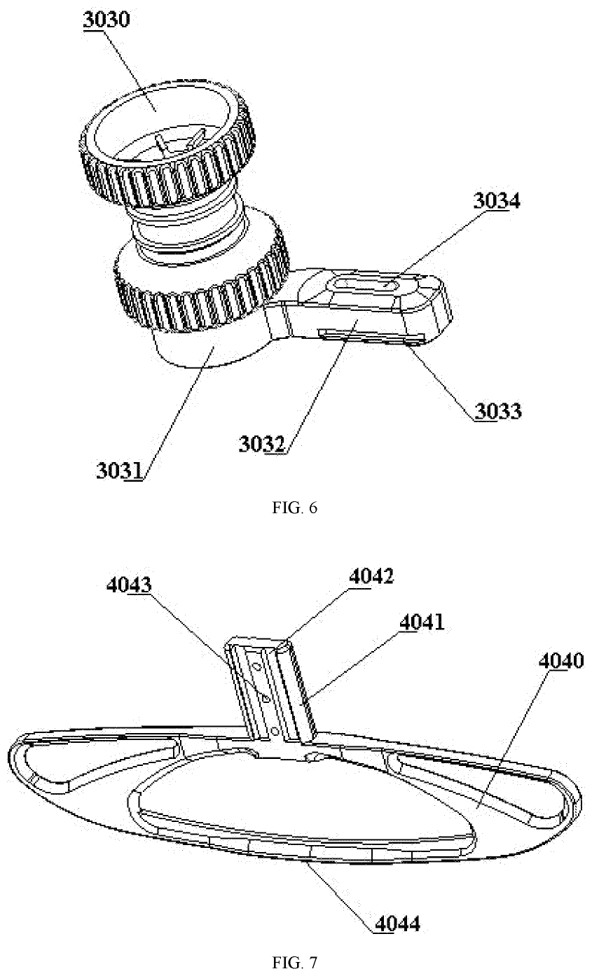

As shown in FIGS. 5 to 6, one of the connecting parts further includes an accommodating cavity 7071 with a first threaded hole 7072 provided on the bottom of the accommodating cavity 7071 and a clamping block 7073 provided on both sides of the accommodating cavity 7071, and a mounting bracket is provided on the trimming wheel device 3000, the mounting bracket comprising a first fixing part 3031 and a second fixing part 3032.
wherein the first fixing part 3031 has a circular structure, the second fixing part 3032 is provided at one end of the first fixing part 3031, the second fixing part 3032 has an elongated structure and is inserted into the accommodating cavity 7071, the third card slot 3033 is provided on both sides of the second fixing part 3032, the third card slot 3033 is formed by extending in the direction of insertion of the second fixing part 3032, and the clamping block 7073 is snapped to the third card slot 3033: wherein the second fixing part 3032 is inserted into the accommodating cavity 7071, and then the second fixing part 3032 is secured by screws inserted into the first threaded hole 7072: by the cooperation of the clamping block 7073 and the third card slot 3033, the strength of the connection thereof can be strengthened, and it also facilitates the removal and replacement of the trimming wheel device 3000. Specifically, the second fixing part 3032 is provided with an elongated slotting 3034: the setting of the slotting 3034 can play a limiting role.

In other embodiments (not shown in the figures), a spring pin can be used as a retaining member, wherein the spring pin is a cylindrical pin with elasticity that can be inserted into the accommodating cavity and fitted tightly against the wall of the accommodating cavity by elastic force to provide a retaining effect. One end of the spring pin is provided with an annular tab for limiting the insertion depth of the spring pin, and the other end is provided with an annular groove for suspending the spring pin with a tool during installation or removal. This structure has a simple structure and is easy to install and remove.

In some embodiments, a snap ring may also be used as a fixing member, wherein the snap ring is an annular piece of metal that fits over the shaft within the accommodating cavity and snaps into the opening of the accommodating cavity through the ends of the snap ring to create a fixing effect. One end of the snap ring is provided with a barb to limit the direction of rotation of the ring, and the other end is provided with a lug for pressing the ring with a tool during installation or removal. This structure is firmly bonded and cannot be easily loosened or deformed.

In some embodiments, there is also the use of an extruded rivet as a fixing member, wherein the extruded rivet is a nail having a hollow mandrel and a rivet head that can be inserted into the accommodating cavity and cause the rivet head to expand by extruding the mandrel to closely fit the wall of the accommodating cavity, thereby creating a fixing effect. One end of the extruded rivet is provided with a flat head for limiting the insertion depth of the extruded rivet, and the other end is provided with a hexagonal hole for rotating the extruded rivet with a tool during installation or disassembly. This structure has a high joint strength and is not easily loosened or deformed, but has the disadvantage of requiring a large amount of force for installation and removal.

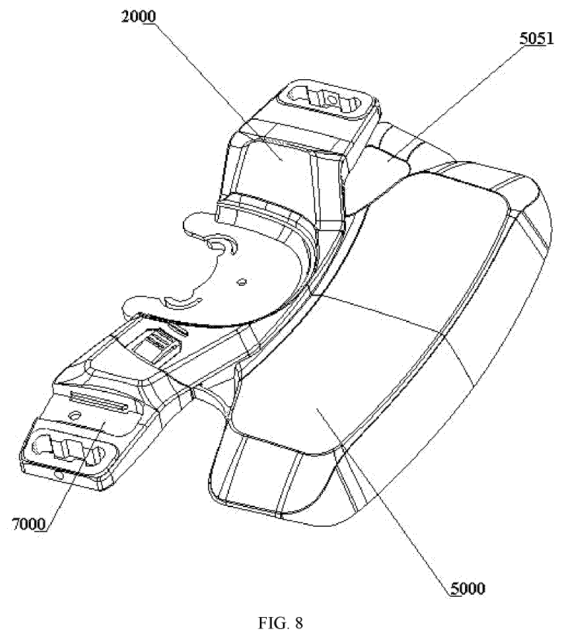

As shown in FIGS. 5 and 7, in this embodiment, the first tank wheel 4040 is provided with the third fixing part 4041, the third fixing part 4041 is provided with a number of grooves 4042, the third fixing part 4041 is provided with a number of second threaded holes 4043, and the connecting part 7000 is provided with a through slot 7074 on both sides of the connecting part 7000, with a plurality of protruding blocks 7075 within the through slot 7074 to mate with the groove 4042, and the connecting part 7000 is provided with a third threaded hole 7076 on the side wall.

When it is necessary to install the first tank wheel 4040, the third fixing part 4041 is inserted into the through slot 7074 so that the protruding block 7075 and the groove 4042 snap into each other, while the third threaded hole 7076 corresponds to one of the second threaded hole 4043, and then it is fixed by the bolts going through the second threaded hole 4043 and the third threaded hole 7076 in turn.

Among other things, the plurality of second threaded holes 4043 can facilitate height adjustment of the first tank wheel 4040. Specifically, the third fixing part 4041 is provided with curved ends, which in turn reduces the difficulty of installing the first tank wheel 4040 and also facilitates its disassembly to adjust the height of the first tank wheel 4040.

As shown in FIG. 7, in this embodiment, first tank wheel 4040 is a frame structure similar in shape to a tank track. And the first tank wheel 4040 is constructed to have a sled surface 4044 for contact with the ground, machine head 1000 in having mode, the sled surface 4044 falls and slides on the ground to allow the user to move the machine head 1000. The sled surface 4044 has upwardly curved ends to allow the first tank wheel 4040 to pass over obstacles such as tree branches on the ground.

In other embodiments (not shown in the figures), the tank wheel is not limited to this shape, but may also be triangular, curved, and other geometric shapes as desired.

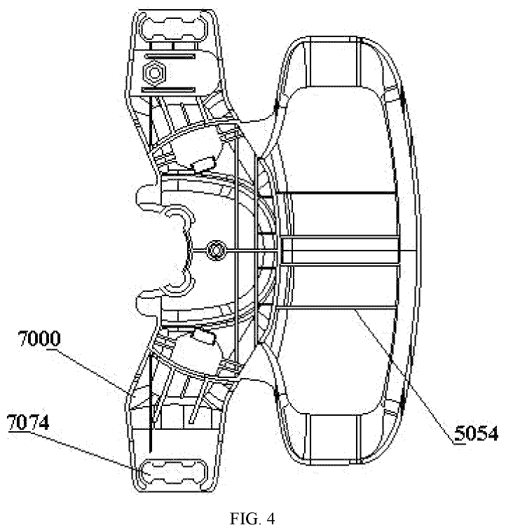

As shown in FIGS. 3 to 4, in this embodiment, cover shell 5000 is composed of a plurality of end faces, wherein two of the end faces have an outer edge with a inclined layer 5052 and one of the end faces has an outer edge with a bending layer 5053, and the inclined layer 5052 and the bending layer 5053 are used to block branches and leaves under the shear of grass trimmer head 1100. More specifically, the cover shell 5000 is provided with a plurality of reinforcing ribs 5054 to ensure the strength of the cover shell 5000 and to prevent the cover shell 5000 from breaking.

In some embodiments (not shown in the figures), it may also be the case that a mesh structure is used as a cover shell, the mesh being a hollow body comprising a plurality of metal wires or strips which is effective in blocking branches and leaves under the grass trimmer head cut, while providing good air permeability and lightness. The mesh structure can be fabricated by welding or weaving to form a polyhedral or cylindrical shape, and the mesh structure is simple and low cost.

In some embodiments, plastic injection molding may also be used as the cover shell, which is a process in which molten plastic material is injected into a mold, cooled, and demolded to form a desired shape, allowing a variety of intricate shapes and structures to be produced. The plastic injection molding can be provided with a plurality of grooves or holes in the cover shell for blocking branches and leaves under the cutout of the grass trimmer head, as well as good waterproofing and corrosion resistance, and the plastic injection molding has an attractive appearance and stable quality.

In some embodiments, there is also the use of metal stamping as cover shell, which is a process that uses a stamping press to deform a sheet of metal through a mold to form a desired shape, which can produce a variety of flat or curved shapes. Metal stamping can have multiple bends or bumps in the cover shell for blocking branches and leaves under the 1100 shear while providing good strength and hardness. Metal stamping is highly efficient and precise.

In this embodiment, there is also a main handle that is convenient for users to pick up and use. The main handle includes a connecting rod and a handle. One end of the connecting rod is fixedly connected to the handle. The other end of the connecting rod is detachably connected to the machine head via a locking component.

Among them, the connecting rod is provided with a connecting component and is composed of two hollow rods connected by a connecting component. Specifically, one rod has an outer diameter not greater than an inner diameter of another rod so that both rods can fit together closely when inserted. The connecting component is provided at an insertion port to lock both rods together. The handle has a control end of an electric motor inside a grass trimmer.

In this embodiment, the connecting rod is set to have an approximately cylindrical shape and has an approximately cylindrical outer surface. Specifically, the connecting rod is set to have a runway shape. In other embodiments (not shown in the figure), the connecting rod is not limited to being set to a runway shape but can also have other geometric shapes such as triangle, circle, quadrilateral or any other geometric shape desired. Similarly, the outer surface of the connecting rod is not limited to being set to a runway shape but can also have other geometric shapes such as triangle, circle, quadrilateral or any other geometric shape desired.

In other embodiments (not shown in the figure), the connecting rod is not limited to the above-mentioned connection method but can also be set as two rods with corresponding threaded structures for connection through threads or any other connection method desired.

In this embodiment, there is an angle adjustment device (not shown in the figure) at the connection between the connecting rod and the grass trimmer. Due to different user heights and usage scenarios, different working angles are required when using the grass trimmer. The angle adjustment device can provide users with working angles required in various usage scenarios for users with different heights.

As shown in FIGS. 13 to 18, a grass trimmer provided in embodiment 2 differs from the grass trimmer of embodiment 1 in that the base 2000, the tank wheel device 4000, and the trimming wheel device 3000 have different structures. In particular, one of the tank wheel devices 4000 is detachably connected to the base 2000, the other tank wheel device 4000 is fixedly connected to the base 2000, the trimming wheel device 3000 is detachably connected to the base 2000, the detachably connected tank wheel device 4000 is replaced in use, and the replaced tank wheel device 4000 and the trimming wheel device 3000 are connected at the same position of the base 2000.

Thereby, when the grass trimmer trims the edges, it is only necessary to install the trimming wheel device 3000 on the base 2000 to support the grass trimmer head 1100 to walk, realizing that the grass trimmer performs the work of trimming the edges: thereby, when the grass trimmer hits the grass, it is only necessary to install the tank wheel device 4000 on the base 2000 to support the grass trimmer head 1100 to walk, realizing that the grass trimmer performs the work of hitting the grass: when pruning plants in high places, it is only necessary to dismantle both the tank wheel device 4000 and the trimming wheel device 3000 so as to reduce the weight of the grass trimmer for ease of pruning.

Among them, the base 2000 and the cover shell 5000 are snap-connected, and the second viewing port 9000 is opened on the cover shell 5000, and the second viewing port 9000 is provided on a side near the removable tank wheel device 4000, which can improve the angular range for observing the movement trajectory of the grass trimmer head 1100.

In other embodiments (not shown in the figures), the connection of the base to the cover shell is not limited to a snap connection, but can also be a threaded connection, a pinned connection, and other connections as desired.

Thus, when the grass trimmer is trimming the plants on the high place, the tank wheel device 4000 or the trimming wheel device 3000 on the base 2000 is disassembled, and under the action of the first viewing port 6000, the observation range can be enlarged so that the range of the movement track of the grass trimmer head 1100 is blocked is smaller, thereby improving the user's visibility, facilitating the trimming of the plant's branches and leaves, and improving the trimming precision of the branches and leaves. At the same time, the gap between the cover shell 5000 and the grass trimmer head 1100 becomes larger, which can reduce the phenomenon of hanging grass; and can also reduce the weight of the grass trimmer, so that the user can hold it more conveniently, especially some people with less strength, can also be able to trim plants in high places, which improves the work efficiency.

In addition, one of the end surfaces of the base 2000 and the cover shell 5000 is designed to overlap so that when the branches and leaves of higher plants are trimmed, the trimmed branches and leaves will not injure the user, improving the grass blocking area of the cover shell 5000 and increasing safety when trimming.

Specifically, the trimming wheel device 3000 includes a second trimming wheel 9010, a first connecting piece 9011, and a first connecting frame 9012, and an installation cavity 9017 is provided between the base 2000 and the first connecting frame 9012 at one end, and the first connecting frame 9012 is mounted to and the installation cavity 9017: the first connecting frame 9012 is connected to the first connecting piece 9011 at the other end, and the second trimming wheel 9010 is rotatably connected to the first connecting piece 9011, and the second trimming wheel 9010 serves the same function and has the same structure as the first trimming wheel 3030.

The tank wheel device 4000 comprises a second connecting piece 9013, a second connecting frame 9014, a second tank wheel 9015, and a third tank wheel 9016; the second connecting frame 9014 and the first connecting frame 9012 have the same structure, one end of the second connecting frame 9014 is detachably connected within the installation cavity 9017 and the other end is connected to the second connecting piece 9013, and the second tank wheel 9015 and the third tank wheel 9016 are detachably connected to the second connecting piece 9013 and the base 2000, respectively, and the second tank wheel 9015 and the third tank wheel 9016 are both identical in structure to the first tank wheel 4040.

When the grass trimmer is in the trimming mode, the trimming wheel device 3000 is installed in the installation cavity 9017, the grass trimmer is held relatively upright so that the second trimming wheel 9010 falls to the ground supporting the machine head 1000, and the second trimming wheel 9010 can be rolled on the ground to allow the user to move the machine head 1000 to complete the trimming of the plant.

When the grass trimmer is in the having mode, the tank wheel device 4000 is mounted in the installation cavity 9017, and the base 2000 is also mounted at the other end with the second tank wheel 9015, so that the second tank wheel 9015 and the third tank wheel 9016 are supported under the machine head 1000, which facilitates driving the machine head 1000 to the ground so that the user can move the machine head 1000 for having and cutting.

Through the above settings, it makes the grass trimmer work in two different modes, that is, it can meet the basic working requirements, and at the same time, it can reduce the weight of the grass trimmer and make its operation more convenient.

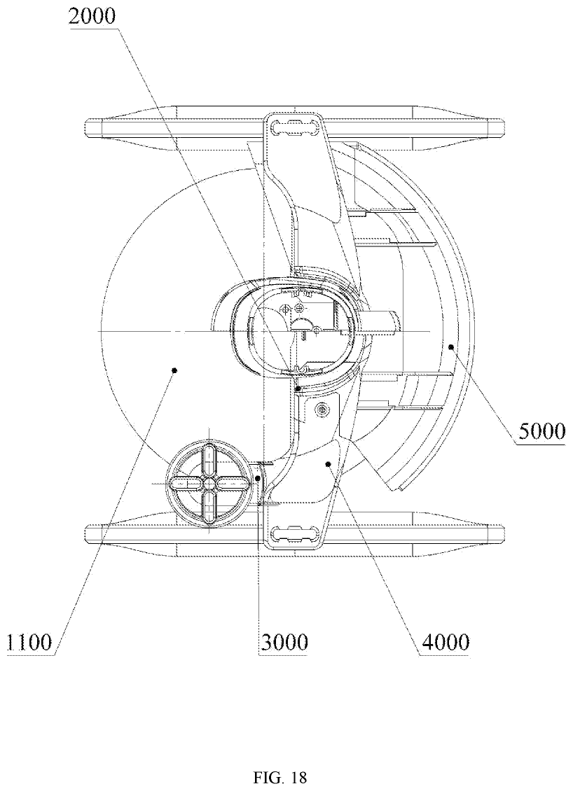

As shown in FIG. 18, in another embodiment, the trimming wheel device 3000 and the tank wheel device 4000 are fixedly connected and may be molded as one piece, or the trimming wheel device 3000 may be bonded or welded to the tank wheel device 4000.

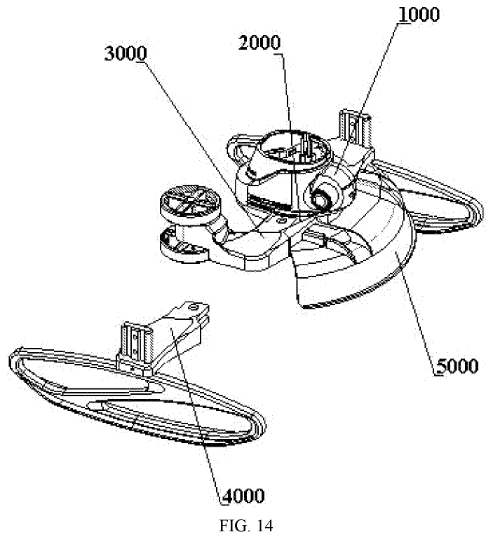

As shown in FIGS. 13 to 14, the present embodiment thickens the overall thickness of the base 2000, which means that the internal cavity of the installation cavity 9017 is deeper, thereby strengthening the strength of the connection between the trimming wheel device 3000, the tank wheel device 4000 and the installation cavity 9017 to ensure overall firmness, and at the same time better supporting the machine head 1000 to ensure smooth operation of the grass trimmer.

In other embodiments (not shown in the drawings), in order to strengthen the connection strength of the trimming wheel device, the tank wheel device and the installation cavity to ensure the overall strength, and also to better support the machine head and ensure the smooth operation of the grass trimmer, a composite material is used as the material of the base, and a composite material is a new type of material that is a combination of two or more materials having different properties, which can combine the various materials It can combine the advantages of various materials, thus improving the performance and function of the base. Composite materials can be combined in different ways and proportions according to different needs, such as metal matrix composites, ceramic matrix composites, resin matrix composites and so on.

The composite material can make the base have higher strength, rigidity, abrasion resistance, corrosion resistance and other characteristics, so as to strengthen the connecting strength between the trimming wheel device, tank wheel device and installation cavity and ensure the overall rigidity, and at the same time, it can also better support the machine head and ensure the smooth operation of the grass trimmer.

In some embodiments, it may also be the case that a cushioning device is used as an additional structure to the base, the cushioning device being a device used to minimize damage to the structure caused by shock or vibration, which absorbs or disperses the forces exerted by the outside world on the structure, and thus protects the integrity and stability of the structure. Cushioning devices can be spring-loaded, rubberized, hydraulic, etc. to achieve the cushioning effect.

The cushioning device may be installed between the base and the trimming wheel device, tank wheel device, or between the base and the machine head to reduce the shock or vibration to which the grass trimmer is subjected during operation, to ensure the strength of the connection between the trimming wheel device, tank wheel device, and installation cavity, to ensure overall firmness, and to better support the 1000 to ensure smooth operation of the grass trimmer.

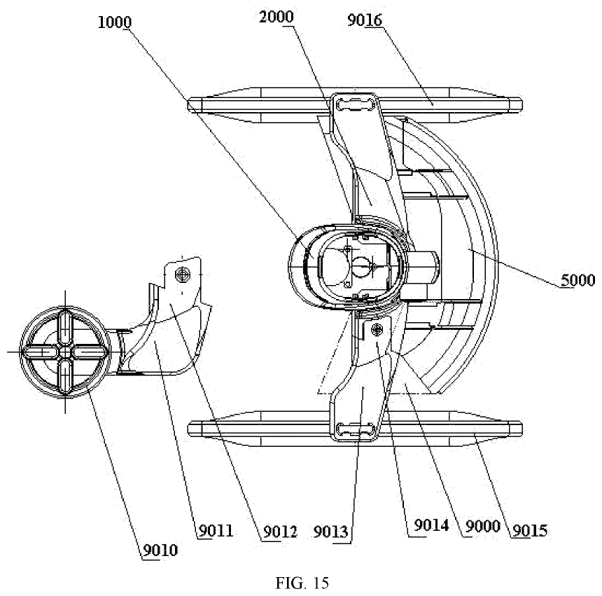

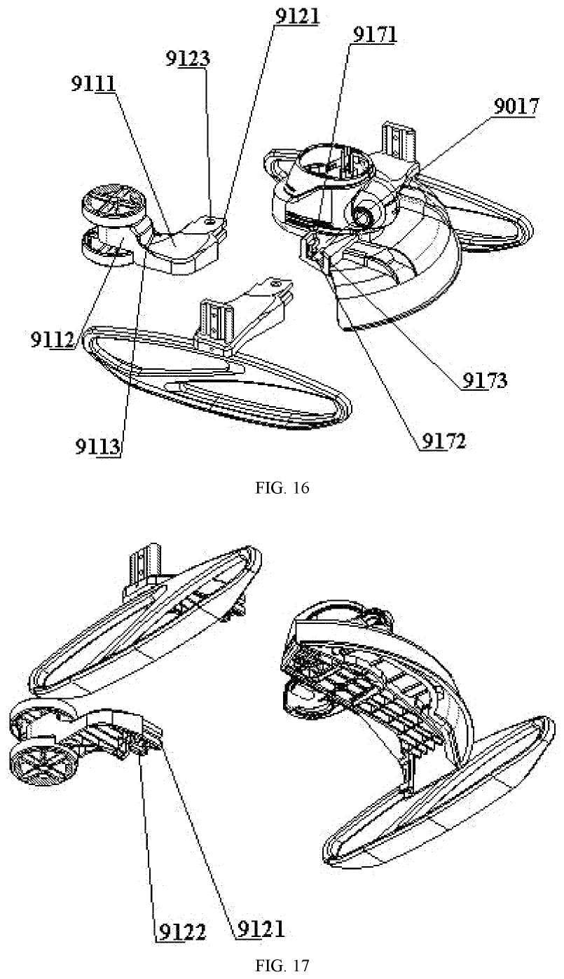

As shown in FIGS. 15 to 16, in this embodiment, first protruding block 9171 is provided on both sides of installation cavity 9017, second protruding block 9172 is provided on the bottom of installation cavity 9017, and fourth threaded hole 9173 is provided on second protruding block 9172: a first accommodating slot 9121 is provided on both sides of the first connecting frame 9012 corresponding to the first protruding block 9171, and a second accommodating slot 9122 is provided on the bottom of the first connecting frame 9012 corresponding to the second protruding block 9172, and a fifth threaded hole 9123 is provided within the second accommodating slot 9122 corresponding to the fourth threaded hole 9173.

Wherein the first connecting frame 9012 is inserted into the installation cavity 9017 so that the first protruding block 9171 and the second protruding block 9172 are inserted into the first accommodating slot 9121 and the second accommodating slot 9122, respectively, and then secured by bolts inserted into the fourth threaded hole 9173 and the fifth threaded hole 9123: thereby facilitating the mounting and dismounting of the trimming wheel device 3000 and the tank wheel device 4000 by the cooperation of the first connecting frame 9012 and the installation cavity 9017.

As shown in FIG. 15, in this embodiment, first connecting piece 9011 includes first extension part 9111, second extension part 9112: first extension part 9111 is provided with second extension part 9112, second trimming wheel 9010 is provided on second extension part 9112, and first extension part 9111 and second extension part 9112 are connected to form an “L” shape.

With this setting, the distance between the second trimming wheel 9010 and the machine head 1000 can be reduced, and the center of gravity of the grass trimmer head 1100 can be ensured without affecting the movement trajectory of the grass trimmer head 1100, so that the grass trimmer head 1100 is more stable under the rolling of the second trimming wheel 9010 and more convenient to cut: at the same time, the distance between the grass trimmer head 1100 and the grass is shortened, so that it is capable of cutting some shorter grasses, thereby improving the effect of use.

Further, a reinforcing part 9113 is provided between the first extension part 9111 and the second extension part 9112, thereby increasing the strength of the connection between the first extension part 9111 and the second extension part 9112.

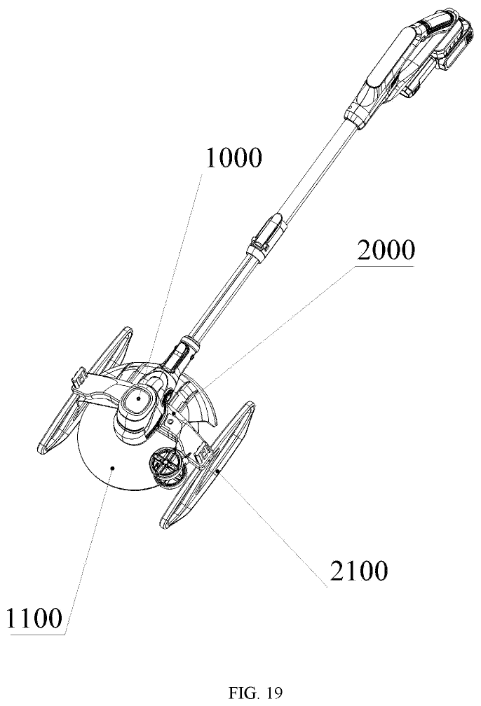

As another preferred embodiment of the present invention, as shown in FIGS. 19 through 21, the present invention also provides another grass trimmer comprising a machine head 1000, the machine head 1000 comprising at least one electric motor (not shown in the drawings), a grass trimmer head 1100 actuated by the electric motor, and a chassis (not shown in the drawings) for housing the electric motor; and a base 2000, the base 2000 comprising a shell for supporting the machine head 1000.

As shown in FIGS. 19 to 21, another preferred embodiment of the present invention further comprises a moving mechanism 2100, wherein the moving mechanism 2100 is detachably attached to the base 2000 for supporting the grass trimmer head 1100 and assisting in the movement of the grass trimmer head 1100 while the grass trimmer head 1100 is operating: wherein the moving mechanism 2100 comprises a trimming wheel device 3000 and a tank wheel device 4000, the trimming wheel device 3000 and the tank wheel device 4000 forming a fixed connection, and a supporting direction of the trimming wheel device 3000 being transverse to a supporting direction of the tank wheel device 4000, wherein the tank wheel device 4000 forms a support for and assists in moving the grass trimmer head 1100 when the grass trimmer head 1100 performs having operations, and the trimming wheel device 3000 forms a support for and assists in moving the grass trimmer head 1100 when the grass trimmer head 1100 performs trimming operations. The grass trimmer head 1100 forms a support for and assists in the movement of the grass trimmer head 1100.

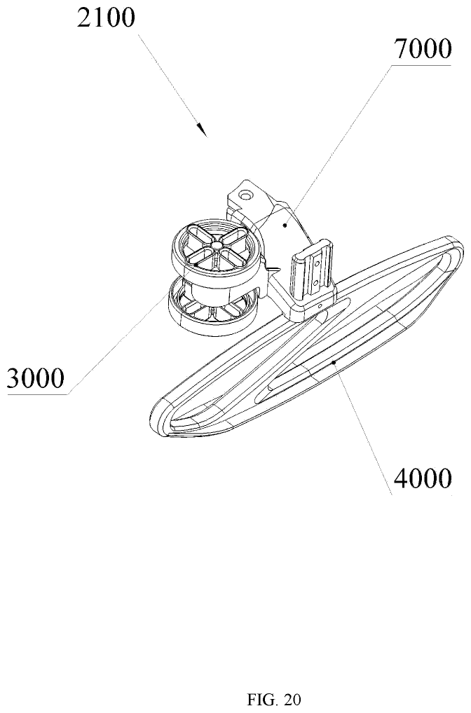

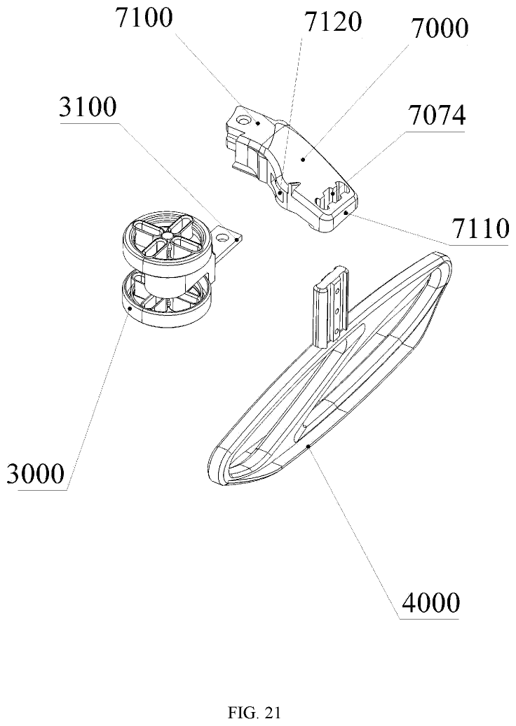

In this embodiment, as shown in FIGS. 20 and 21, the moving mechanism 2100 further includes a connecting part 7000 with a quick-release part 7100 provided on the connecting part 7000 and a mounting part provided on the base 2000, the mounting part receiving and releasing the quick-release part 7100, allowing the moving mechanism 2100 to be quickly removed and installed on the base 2000.

The specific structure of the quick-release part 7100 and the mounting portion can be referred to as a locking structure 8000 in another preferred embodiment of the present invention as shown in FIGS. 3 to 5. In this embodiment, the quick-release part 7100 is preferably configured to be made of plastic which is low in manufacturing cost and at the same time has a certain degree of elasticity which can greatly improve the removal and installation speed of the moving mechanism 2100.

Different from another preferred embodiment of the present invention, the trimming wheel device 3000 and the tank wheel device 4000 of the present embodiment are configured as a single unit, which further satisfies the use needs of some users, and when it is necessary to switch the working state of the grass trimmer, it is only necessary to change the working angle of the grass trimmer, which eliminates the need to replace the step of the trimming wheel device 3000 or the tank wheel device 4000 and further improves the working efficiency.

Specifically, as shown in FIGS. 20 and 21, a connecting boss 4100 is provided on the tank wheel device 4000, the connecting part 7000 has a through slot 7074 and further comprises a fixing hole 7110, wherein the fixing hole 7110 provides a passage for the screws to enter the through slot 7074, and in this embodiment, the 41004110 is threaded through the through slot 7074 and is pressed and held in place by the screws that pass through the fixing hole 7110 to reach the through slot 7074, such that the tank wheel device 4000 forms a fixed connection with the connecting part 7000.

Also as shown in FIGS. 20 and 21, an insert block 3100 is molded in the trimming wheel device 3000 and a 71117120 is provided on the connecting part 7000 for the insert block 3100 to be inserted, and both the insert block 3100 and the 71117120 are provided with pin holes, so that when the insert block 3100 is inserted into the 71117120, the insert block 3100 forms a fixed connection with the 71117120 through the pins, which finally allows the trimming wheel device 3000 and the tank wheel device 4000 to be fixed together through the connecting part 7000.

In some embodiments, in order for the tank wheel device 4000 and the trimming wheel device 3000 to form a fixed connection, the tank wheel device 4000 and the trimming wheel device 3000 may also be formed into a fixed connection by welding. In some embodiments, the tank wheel device 4000 and the trimming wheel device 3000 may also be formed into a fixed connection by riveting. In some embodiments, the fixed connection may also be formed by creating an interference fit between tank wheel device 4000 and trimming wheel device 3000. In some embodiments, to further increase the structural strength of the moving mechanism 2100, the moving mechanism 2100 is configured to be integrally molded.

In this embodiment, as shown in FIG. 3, the cover shell 5000 is also included, the cover shell 5000 forms a fixed connection with base 2000 and forms a half-envelope for grass trimmer head 1100, which can form a protection for the user to prevent grass trimmer head 1100 from accidentally injuring the user while working, and also to avoid the convenience of cleaning up the operation after completing the having work. Also as shown in FIG. 3, the first viewing port 6000 is also opened on the cover shell 5000, and the first viewing port 6000 can observe the movement trajectory of the grass trimmer head 1100 when the grass trimmer is working.

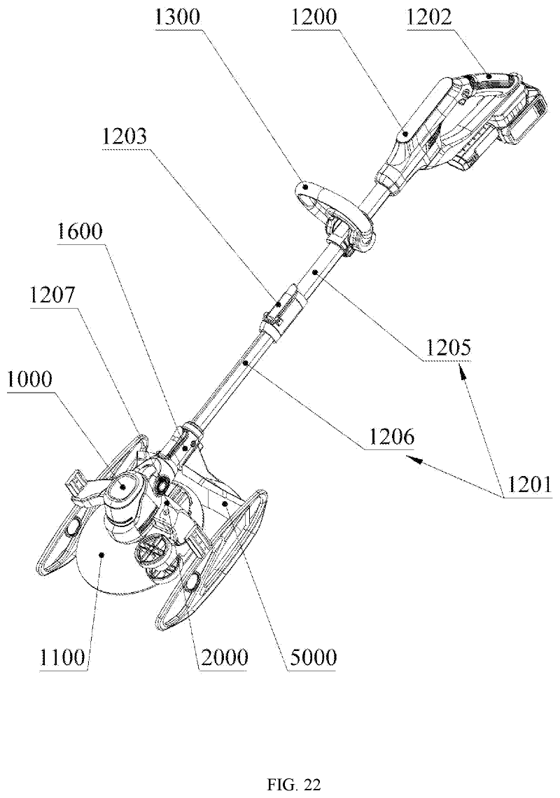

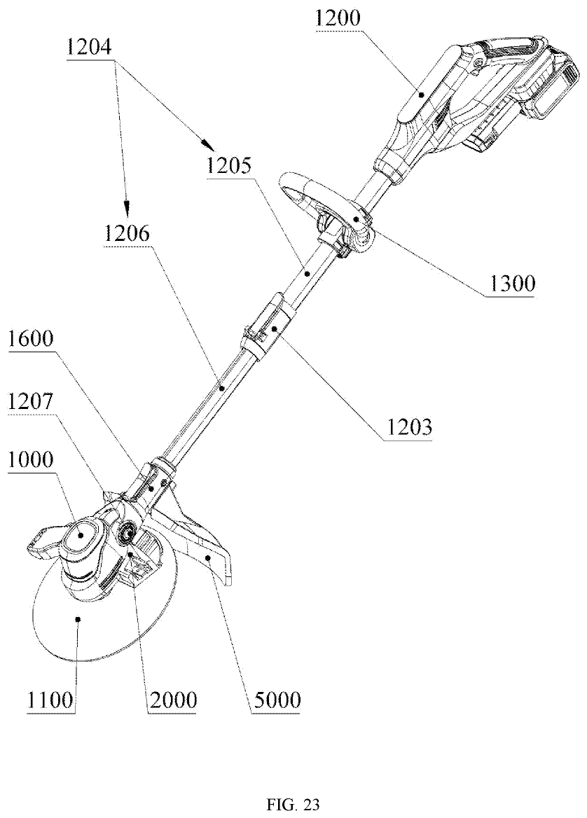

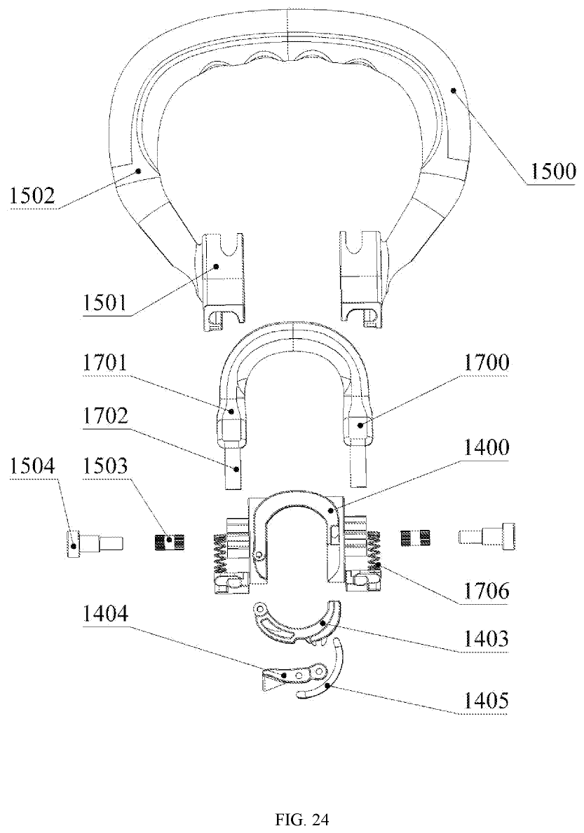

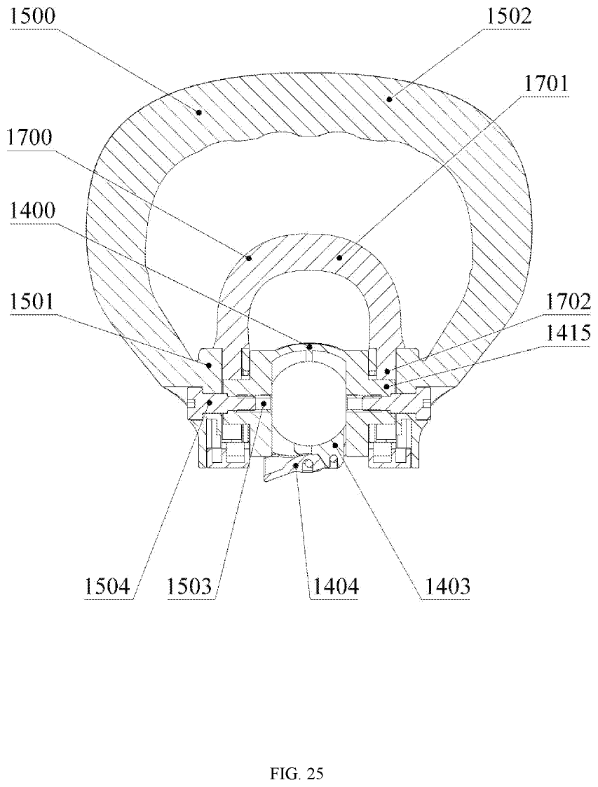

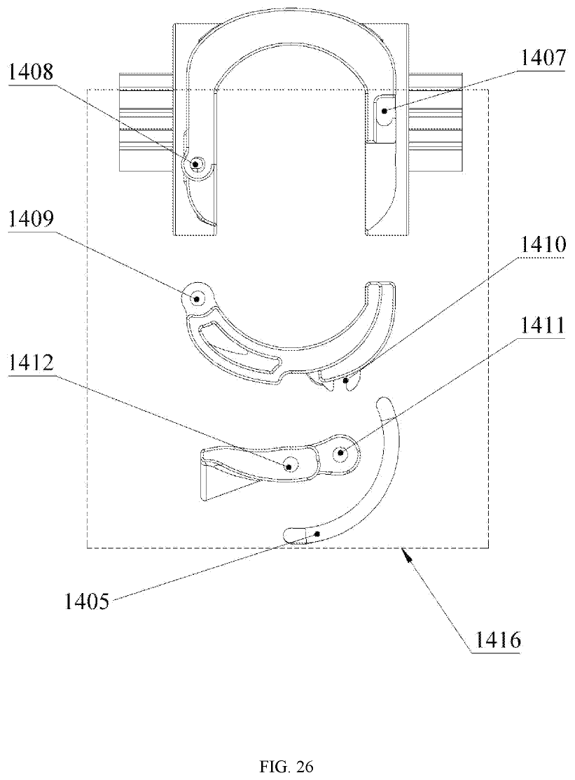

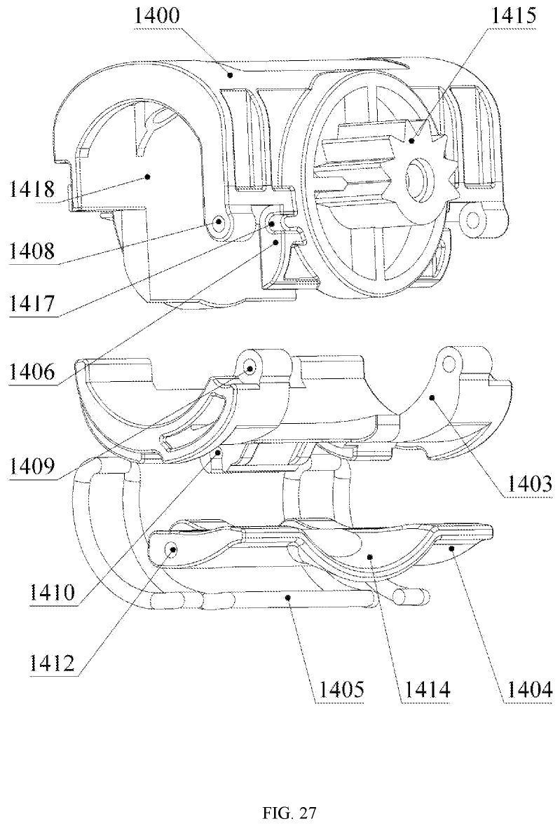

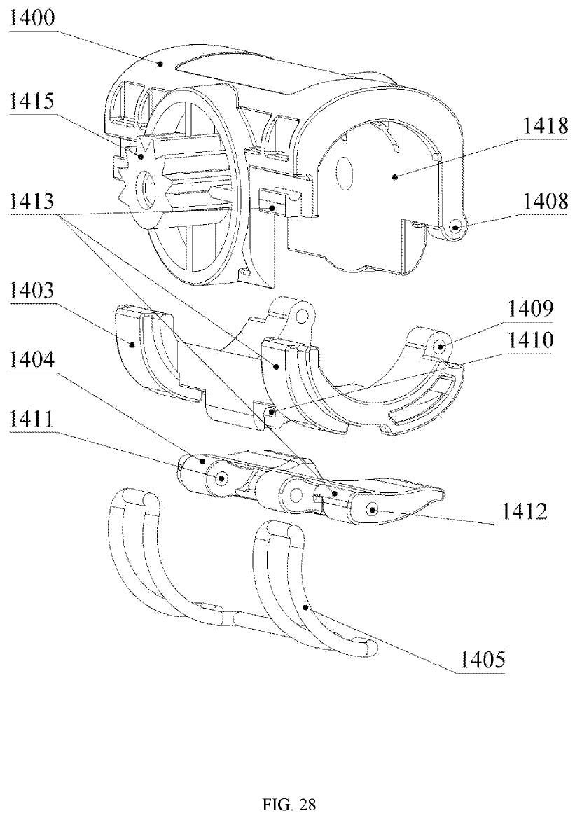

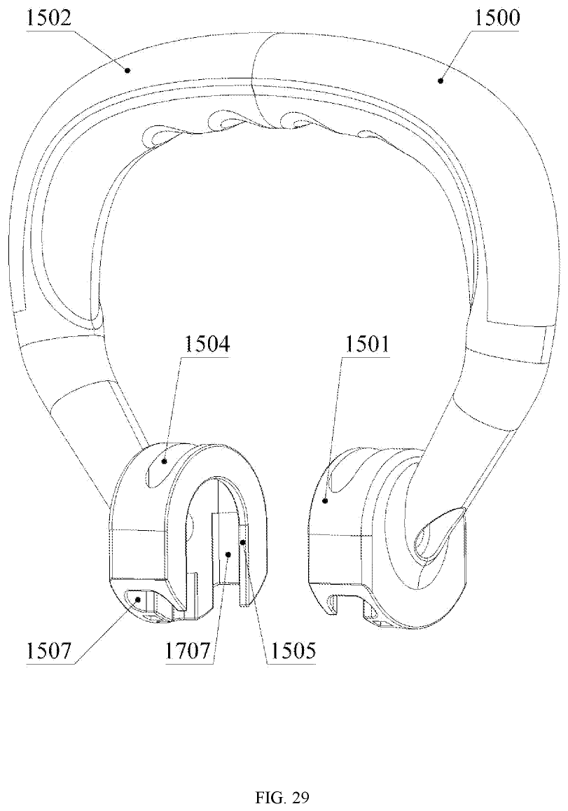

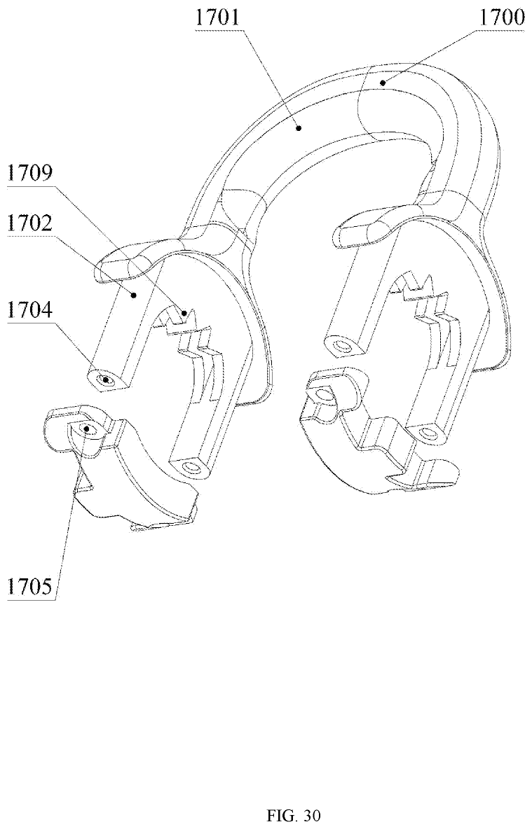

In the third embodiment shown in FIGS. 22 to 30, a grass trimmer is provided. It includes a main handle 1200 that is convenient for users to pick up and use. The main handle 1200 includes a connecting rod 1201 and a handle 1202. One end of the connecting rod 1201 is fixedly connected to the handle 1202. The other end of the connecting rod 1201 is detachably connected to the machine head 1000 via a locking component 1600.

Wherein, the connecting rod 1201 is provided with a connecting component 1203 and is composed of two hollow rods 1204 connected by the connecting component 1203. It includes a first rod 1205 and a second rod 1206. The outer diameter of the first rod 1205 is not greater than the inner diameter of the second rod 1206, so that the first rod 1205 can be inserted into and tightly fit with the second rod 1206. The connecting component 1203 is provided at an insertion port to lock both rods together. The handle 1202 has a control end of an electric motor inside a grass trimmer.

In this embodiment, the connecting rod 1201 is set to have an approximately cylindrical shape and has an approximately cylindrical outer surface. Specifically, the connecting rod 1201 is set to have a runway shape. In other embodiments (not shown in the figure), the connecting rod is not limited to being set to a runway shape but can also have other geometric shapes such as triangle, circle, quadrilateral or any other geometric shape desired. Similarly, the outer surface of the connecting rod is not limited to being set to a runway shape but can also have other geometric shapes such as triangle, circle, quadrilateral or any other geometric shape desired.

In this embodiment, the rods in the connecting rod 1201 are made of aluminum tubes. In other embodiments (not shown in the figure), the rods are not limited to aluminum tubes but can also be iron tubes, plastic tubes, alloy steel tubes or any other material desired.

In other embodiments (not shown in the figure), the connecting rod is not limited to the above-mentioned connection method but can also be set as two rods with corresponding threaded structures for connection through threads or any other connection method desired.

In this embodiment, there is an angle adjustment device 1207 at the connection between the locking component 1600 and the machine head 1000. Due to different user heights and usage scenarios, different working angles are required when using the grass trimmer. The angle adjustment device can provide users with working angles required in various usage scenarios for users with different heights.

As shown in FIGS. 22 to 30, a grass trimmer provided in embodiment 3, which is different from the grass trimmers of Embodiments One and Two, further includes an adjustable angle secondary handle 1300. The secondary handle 1300 is detachably attached to a connecting rod 1201 of a main handle 1200. The secondary handle 1300 includes a connecting pipe 1400, an auxiliary handle 1500, and an adjustment handle 1700. The auxiliary handle 1500 is rotatably attached to the connecting pipe 1400, and the adjustment handle 1700 is inserted into the auxiliary handle 1500 and abuts against the connecting pipe 1400.

In this embodiment, the connecting pipe 1400 is set as a tubular structure corresponding to the connecting rod 1201 of the main handle 1200. The tubular structure has an approximately cylindrical inner wall surface 1418 corresponding to the outer surface shape of the connecting rod 1201. The inner wall surface 1418 defines a space for accommodating the connecting rod. The connecting pipe 1400 is also provided with an opening that delimits a channel for the main handle 1200 to enter and exit the space. Furthermore, the connecting pipe 1400 is equipped with a buckle structure 1416 that can close or open the opening and restrict displacement of the main handle 1200 entering the space. Additionally, the connecting pipe 1400 is also equipped with an angle adjustment mechanism for adjusting angles between the auxiliary handle 1500 and adjustment handle 1700 with respect to the connecting pipe 1400. Specifically, angle adjustment mechanisms are respectively arranged on both sides of the connecting pipe 1400. In this embodiment, angle adjustment mechanisms are set as gears 1415 that limit rotation of the auxiliary handle 1500 and adjustment handle 1700.

Wherein, the buckle structure 1416 includes a first block 1403 and a second block 1404, the first block 1403 and the second block 1404 are configured to have mutually fitting shapes, the first block 1403 is rotatably hinged to the connecting pipe 1400, the second block 1404 is detachably hinged to the first block 1403, the buckle structure also includes a buckle ring 1405, the buckle ring 1405 is rotatably fixedly connected to the second block 1404.

Specifically, the connecting pipe 1400 includes a connection platform 1406 and a buckle groove 1407, the connecting pipe 1400 is provided with at least one through hole A1408, the connection platform 1406 is provided with a receiving groove 1417 corresponding to the through hole A1408, one end of the first block 1403 is provided with at least one through hole B1409 corresponding to the through hole A1408, the connection platform 1406 and the first block 1403 are rotatably hinged by a pin nail: another end of the first block 1403 is provided with at least one groove C1410, one end of the second block 1404 is provided with at least one through hole D1411 corresponding to the groove C1410, the first block 1403 and the second block 1404 are detachably hinged by a pin nail: the buckle ring 1405 is configured to have an open ring-shaped structure, another end of the second block 1404 is provided with a through hole E1412 having an inner diameter not smaller than the outer diameter of the buckle ring 1405, one end of the buckle ring 1405 is inserted into the through hole E1412 to form a rotatable connection: the second block 1404, the first block 1403 and the buckle groove 1407 are provided with an embedded part 1413, the embedded part 1413 is configured to have a shape that can accommodate by the buckle ring 1405, the buckle ring 1405 is buckled to the buckle groove 1407 by the embedded part 1413: another end of the second block 1404 near the through hole E1412 is also provided with a locking part 1414, which assists in closing and opening of the buckle structure 1416.

In this embodiment, the tubular structure has a substantially cylindrical inner wall surface 1418 corresponding to the outer surface shape of the connecting rod, specifically, the inner wall surface 1418 is configured as a runway shape. In other embodiments (not shown in the figure), the inner wall surface corresponding to the outer surface of the connecting rod is not limited to being configured as a runway shape, but can also be a triangle, circle, quadrilateral or any other geometric shape that meets the desire.

In other embodiments (not shown in the figure), the connection mode of the connection platform and the first block, and the first block and the second block is not limited to pin nail connection, but can also be set as screw connection, rivet connection or any other connection mode that meets the desire.

In this embodiment, the auxiliary handle 1500 is configured as a ring-shaped structure, and the auxiliary handle 1500 includes an adjustment box body 1501 and a first ring part 1502, the adjustment box body 1501 and the first ring part 1502 are fixedly connected, and the connection part of the adjustment box body 1501 and the first ring part 1502 is provided with a through hole corresponding to the gear 1415, a bushing 1503 and an axle nail 1504 are inserted in the through hole, wherein, the bushing 1503 and the axle nail 1504 are mutually matched so that the auxiliary handle 1500 and the adjustment handle 1700 can rotate relative to the connecting pipe 1400.

Wherein, the adjustment box body 1501 includes a first opening 1505, the first opening 1505 is opened on a side close to the connecting pipe 1400, and has a substantially arch shape, for limiting the passage of the gear 1415 entering the adjustment box body 1501, wherein, the adjustment box body 1501 also includes a second opening 1506, the second opening 1506 is opened at an upper end of the adjustment box body 1501, for limiting the passage of the adjustment handle 1700 entering the adjustment box body 1501.

In this embodiment, the adjustment box body 1501 and the first ring part 1502 are integrally formed and fixedly connected, the first ring part 1502 is provided with a shape that conforms to human hand gripping, and is provided with anti-slip texture. In other embodiments (not shown in the figure), the connection mode of the adjustment box body 1501 and the first ring part 1502 is not limited to integral molding, but can also be set as welding, threaded connection, pin nail connection or any other connection mode that meets the desire.

In this embodiment, the adjustment handle 1700 includes a second ring part 1701, an adjustment part 1702 and an adjustment base 1703, the second ring part 1701 and the adjustment part 1702 are fixedly connected, the adjustment part 1702 and the adjustment base 1703 are fixedly connected, wherein, the second ring part 1701 and the adjustment part 1702 are integrally formed and fixedly connected, the adjustment part 1702 is provided with a blind hole M1704, the adjustment base 1703 is provided with a through hole N1705 corresponding to the blind hole M1704, the adjustment part 1702 and the adjustment base 1703 are fixedly connected by the blind hole M1704 and the through hole N1705.

Wherein, the adjustment part 1702 is also provided with a wheel tooth part 1709 corresponding to the gear 1415, the wheel tooth part 1709 and the gear 1415 are mutually engaged to limit the relative rotation of the auxiliary handle 1500 and the adjustment handle 1700 to the connecting pipe 1400, the adjustment part 1702 can enter the adjustment box body 1501 through the second opening 1506, wherein, the adjustment box body 1501 also includes a third opening 1507, the third opening 1507 is provided at a bottom of the adjustment box body 1501, the adjustment base 1703 is fixedly connected to the adjustment part 1702 through the third opening, the third opening 1507 limits the passage of the adjustment base 1703 entering the adjustment box body 1501.

Wherein, the adjustment base 1703 is also provided with a spring 1706, the adjustment box body 1501 is provided with a corresponding accommodating groove 1707 for receiving the spring 1706, and also has a contact surface for limiting the displacement of the spring 1706.

When adjusting the angle of the secondary handle, pull up the adjustment handle, the adjustment base moves toward the direction close to the adjustment handle, the spring compresses toward the direction close to the adjustment handle, the wheel tooth part moves away from the gear, rotate the adjustment handle or the auxiliary handle to adjust to the desired angle, put down the adjustment handle, the spring rebounds, and the wheel tooth part engages with the gear.

As shown in FIGS. 22 to 30, another difference between this embodiment and Embodiments One and Two is that, the cover shell 5000 is detachably attached to the locking component 1600 of the grass trimmer head, specifically, the locking component 1600 and the cover shell 5000 are provided with corresponding buckle structures, thereby achieving a buckle connection.

Specifically, the cover shell 5000 detached from the base 2000 can provide a larger visual opening for users to observe the running trajectory and working condition of the grass trimmer head when performing grass trimming or edging work, increase the visual area, and further improve the work accuracy.

In other embodiments (not shown in the figure), the connection mode of the locking mechanism and the cover shell is not limited to buckle connection, but can also be set as screw connection, pin nail connection, rivet connection or any other connection mode that meets the desire.

The present invention also provides a method of using a grass trimmer, the method comprising: providing a grass trimmer, the grass trimmer comprising at least one electric motor, and a grass trimmer head, a base, a trimming wheel device, and a tank wheel device actuated by the electric motor, wherein the at least one tank wheel device is removably coupled to the base and the at least one trimming wheel device is removably coupled to the base and replaces the at least one of the 4000s in use.

Specifically, when a trimming operation is to be performed using the grass trimmer provided by the present invention: mounting the trimming wheel device on the base or replacing one of the tank wheel devices on the base with the trimming wheel device: standing the grass trimmer on its side with the trimming wheel device touching the ground and supporting the grass trimmer: flipping the switch on the electric motor, the electric motor driving the grass trimmer head to rotate the cut; and driving the grass trimmer to the place where a trimming operation is required to be performed and performing a trimming operation. When it is necessary to perform a having operation using the grass trimmer

provided by the present invention: mounting the tank wheel device on the base or replacing one of the trimming wheel devices on the base with a tank wheel device: the tank wheel supports the grass trimmer: turning on the switch of the electric motor, the electric motor drives the grass trimmer head to rotate for cutting; and driving the grass trimmer to the place where a trimming operation is to be performed and a having operation is to be performed:

When it is necessary to perform trimming operations on plants in high places: remove all the tank wheel device and trimming wheel device on the base, turn on the electric motor switch, the electric motor drives the grass trimmer head to rotate for cutting and lift said grass trimmer to the desired completion of the having operation to perform trimming operations on plants in high places.

In addition, there are some use scenarios where trimming needs to be done on plants on a wall or roof: disassembling all of the tank wheel device and the trimming wheel device on the base, mounting the grass trimmer on a retractable pole, with a handle at one end of the pole for controlling the direction and angle of the grass trimmer: flipping the switch of the electric motor, the electric motor driving the grass trimmer head to rotate and cut; extending or shortening the pole to move the grass trimmer to the place where the pruning operation needs to be completed, and realizing the pruning operation on the plants on a wall or on a roof.

When it is necessary to perform pruning operations on plants of different shapes or sizes: install the trimming wheel device on the base or replace one of the tank wheel devices on the base with the trimming wheel device: replace the grass trimmer head with blades of different shapes or sizes, which may be round, triangular, square, etc., or of different diameters or lengths: turn on the electric motor switch, and the electric motor drives the grass trimmer head to rotate and cut: push the grass trimmer to the place where the pruning operation is to be performed and perform pruning operations on plants of different shapes or sizes.

The technical means disclosed in the scheme of the present invention are not limited to the technical means disclosed in the above embodiments, but also include the technical scheme composed of any combination of the above technical features. It should be pointed out that for those skilled in the art, several improvements and embellishments can be made without departing from the principle of the present invention, and these improvements and embellishments are also regarded as the protection scope of the present invention.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

What is claimed is:

1. A grass trimmer comprising:
a machine head comprising at least one electric motor, a grass trimmer head driven by the electric motor, and a housing for containing the electric motor; and
a base comprising a shell for supporting the machine head; and
a trimming wheel device that assists in moving the grass trimmer head during trimming operations; and
in addition, at least one tank wheel device that assists in moving the grass trimmer head during mowing operation. The tank wheel device and the trimming wheel device form a detachable connection to the base. When trimming is required, the base is connected to the trimming wheel device. When mowing is required, the tank wheel device replaces the connection between the trimming wheel device and the base.

2. The grass trimmer according to claim 1, wherein said tank wheel device forms a detachable connection with said trimming wheel device at the same connection position as said base.

3. The grass trimmer according to claim 1, wherein said base is provided with an installation cavity, and said trimming wheel device comprises a first connecting frame, a first connecting piece, and a second trimming wheel, said first connecting frame being insertable into said installation cavity, said first connecting piece being fixedly connected to an end of said first connecting frame, and said second trimming wheel forming a rotatable connection with said first connecting piece.

4. The grass trimmer according to claim 3, wherein said installation cavity is provided with a fourth threaded hole and said first connecting frame is provided with a fifth threaded hole, said fifth threaded hole corresponding to said fourth threaded hole, said first connecting frame being bolted to said installation cavity.

5. A grass trimmer according to claim 1, wherein said tank wheel device comprises a first tank wheel, said first tank wheel being provided with at least one sled surface in contact with the ground.

6. The grass trimmer according to claim 1, further comprising a cover shell, said cover shell being provided with at least one reinforcing rib.

7. The grass trimmer according to claim 6, wherein said cover shell is provided with a first viewing port.

8. The grass trimmer according to claim 1, wherein said tank wheel device comprises at least one connecting part, whereby one end of said connecting part is detachably attached to said base.

9. The grass trimmer according to claim 8, wherein said base has a face abutting said connecting part, said face being provided as a curved surface.

10. The grass trimmer according to claim 8, wherein said connecting part is provided with a locking structure at one end of said connecting part near said base.

11. A grass trimmer comprising:
a machine head comprising at least one electric motor, a grass trimmer head actuated by said electric motor, and a housing for holding said electric motor; and
a base comprising a shell for supporting the machine head; and
a moving mechanism removably attached to said base for supporting said grass trimmer head and for assisting in the movement of said grass trimmer head while said grass trimmer head is in operation; and
wherein the moving mechanism comprises a trimming wheel device and a tank wheel device, said trimming wheel device forming a fixed connection with said tank wheel device, and said trimming wheel device being supported in a direction transverse to the supporting direction of said tank wheel device; and
wherein said tank wheel device forms a support for said grass trimmer head and assists in the movement of said grass trimmer head when said grass trimmer head is engaged in having operations, and said trimming wheel device forms a support for said grass trimmer head and assists in the movement of said grass trimmer head when said grass trimmer head is engaged in trimming operations.

12. The grass trimmer according to claim 11, further comprising a connecting part, said moving mechanism being detachably attached to said base through said connecting part.

13. The grass trimmer according to claim 12, wherein said connecting part is provided with a quick-release part, said connecting part being detachably attached to said base through said quick-release part.

14. The grass trimmer according to claim 13, wherein said quick-release part is made of plastic.

15. The grass trimmer according to claim 14, wherein said base is provided with a mounting portion, said mounting portion receiving and releasing said quick-release part so that said moving mechanism can be quickly removed and installed on said base.

16. The grass trimmer according to claim 15, wherein said tank wheel device and said trimming wheel device are each formed into a fixed connection with said connecting part.

17. The grass trimmer according to claim 11, further comprising a cover shell, said cover shell being in fixed connection with said base and forming a semi-enclosure for said grass trimmer head.

18. The grass trimmer according to claim 17, wherein said cover shell is provided with a first viewing port, said first viewing port being capable of observing the trajectory of said grass trimmer head during operation of said grass trimmer.

19. A method of using a grass trimmer comprising providing a grass trimmer, said grass trimmer comprising at least one electric motor, and a grass trimmer head, a base, a trimming wheel device, and a tank wheel device actuated by said electric motor, wherein at least one of said tank wheel devices is detachably coupled to said base, and wherein at least one of said trimming wheel devices is detachably coupled to said base and is used to replace at least one of said tank wheel devices when in use; and
mounting the trimming wheel device to the base such that the trimming wheel device supports the grass trimmer and pushes the grass trimmer to move for trimming operations; and
removing said trimming wheel device and mounting said tank wheel device to said base such that said tank wheel device supports said grass trimmer and pushes said grass trimmer to move for mowing operations; and
removing all the tank wheel device and the trimming wheel device from the base to lift the grass trimmer high enough to perform trimming operations on tall vegetation.

20. A grass trimmer comprising:
a machine head comprising at least one electric motor, a grass trimmer head actuated by said electric motor, and a housing for holding said electric motor; and
a base comprising a shell for supporting the machine head; and
a moving mechanism removably attached to said base for supporting said grass trimmer head and for assisting in the movement of said grass trimmer head while said grass trimmer head is in operation; and
a main handle removably attached to said machine head for holding said grass trimmer for operation; and
said main handle comprising a connecting rod and a handle, said connecting rod being fixedly connected to said handle; and
a secondary handle detachably attached to said connecting rod for assisting said main handle in controlling said grass trimmer for operation; and
said secondary handle comprising a connecting pipe, an auxiliary handle, and an adjustment handle, said auxiliary handle being rotatably attached to said connecting pipe, said adjustment handle being threaded through said auxiliary handle and against said connecting pipe; and
said connecting pipe having a generally cylindrical shaped inner wall surface, said inner wall surface defining a space, said space accommodating said connecting rod, said connecting pipe being further provided with an opening, said opening defining a passage for said main handle to enter said space, said connecting pipe being further provided with a buckle structure, said buckle structure being closable or openable to said opening and restricting the displacement of said main handle entering said space, said connecting pipe being further provided with an angle adjustment mechanism for adjusting the angle between said auxiliary handle and said adjustment handle and said connecting pipe.
